(19) United States
(12) Patent Application Publication
(10) Pub. No.: US 2018/0158158 A1
(43) Pub. Date: Jun. 7, 2018

(54) MUNICIPAL SOLVENCY INDEX

(71) Applicant: Diane Coogan-Pushner, Fairfield, CT (US)

(72) Inventor: Diane Coogan-Pushner, Fairfield, CT (US)

(21) Appl. No.: 15/834,294

(22) Filed: Dec. 7, 2017

Related U.S. Application Data
(60) Provisional application No. 62/431,026, filed on Dec. 7, 2016.

(51) Int. Cl. G06Q 50/18; G06F 17/30; G06N 5/02; G06N 7/00; G06Q 50/26

(52) U.S. Cl. CPC G06Q 50/18; G06F 17/30321; G06Q 50/26; G06N 5/022; G06N 7/005; G06F 17/30294

(57) ABSTRACT

An aspect includes creating a municipal solvency (MSX) database. The creating includes collecting and coding data from public sources about a plurality of municipalities. Predictive models are generated based on contents of the MSX database, the predictive models describing drivers of municipal solvency and predictors of material financial events (MFEs) for each of the municipalities. Probabilities of one or more MFEs are predicted for each of the municipalities, the estimating based on the predictive models. Indices that reflect solvency and a probability of an MFE for at least one of the municipalities are created. The indices are output.

### CROSS-REFERENCE TO RELATED APPLICATION

This application claims the benefit of U.S. Provisional Application No. 62/431,026, filed Dec. 7, 2016, and entitled “MUNICIPAL SOLVENCY INDEX”, the content of which is incorporated herein by reference in its entirety.

### BACKGROUND

Embodiments of the invention relate to municipal solvency, and more specifically, to creating a municipal solvency index for predicting and tracking the solvency of municipalities such as towns, counties, and states.

State and municipal expenditures and tax policies are increasingly being questioned by voters, taxpayers, bond market investors, public sector workers, and pension plan participants. While the municipal bond market is well diversified and largely immune from systemic risk, default events in Detroit and Puerto Rico, General Electric Company's exit from Connecticut, and underfunded public pensions have recently raised concerns among a broad array of constituents.

### SUMMARY

Embodiments of the invention include methods, systems, and computer program products for creating a municipal solvency index. A non-limiting example method includes creating a municipal solvency (MSX) database. The creating includes collecting and coding data from public sources about a plurality of municipalities. Predictive models are generated based on contents of the MSX database, the predictive models describing drivers of municipal solvency and predictors of material financial events (MFEs) for each of the municipalities. Probabilities of one or more MFEs are predicted for each of the municipalities, the estimating based on the predictive models. Indices that reflect solvency and a probability of an MFE for at least one of the municipalities are created. The indices are output.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The features and advantages of the invention are apparent from the following detailed description taken in conjunction with the accompanying drawings in which:

FIG. 1 depicts an overview of a process for creating a municipal solvency (MSX) index in accordance with one or more embodiments;

FIG. 2 depicts an overview of a contents of a MSX database in accordance with one or more embodiments;

FIG. 3A and FIG. 3B depict examples of the type of data that are used to generate a MSX database in accordance with one or more embodiments;

FIG. 4 depicts a data collection process for generating contents of a MSX database in accordance with one or more embodiments;

FIG. 5 depicts contents of a MSX database in accordance with one or more embodiments;

FIG. 6 depicts an overview of a process for generating predictive models in accordance with one or more embodiments;

FIG. 7 depicts a process for creating an initial model specification and predictive models in accordance with one or more embodiments;

FIG. 8 depicts a process for performing a quarterly update in accordance with one or more embodiments;

FIG. 9 depicts a process for estimating probabilities of material financial events (MFEs) in accordance with one or more embodiments;

FIG. 10 depicts a process for generating MSX indices in accordance with one or more embodiments;

FIG. 11 depicts a process for producing MSX and MFE indices for a single entity;

FIG. 12 depicts a process for producing composite MSX and MFE indices;

FIG. 13 depicts a process for producing MSX and MFE indices for BLUE components;

FIG. 14 depicts an example of producing MSX and MFE indices in accordance with one or more embodiments;

FIG. 15 depicts a process for performing bond market overlay in accordance with one or more embodiments;

FIG. 16 depicts a block diagram of a system in accordance with one or more embodiments; and

FIG. 17 depicts a block diagram of a system in accordance with one more embodiments.

### DETAILED DESCRIPTION

Embodiments described herein are directed to creating one or more municipal solvency (MSX) indices for predicting and tracking the solvency of municipalities such as towns, counties, and states. The creation of MSX indices can provide the various constituents in the market with a tool to either hedge their risk exposure to a municipality's financial strength or to take a long position on a municipality's financial strength.

Municipal bonds are difficult to sell short, and a short sale of a municipal bond provides little protection to anyone other than the holder of the particular bond. Many stakeholders have exposure to municipal finance, but no exposure to municipal bonds, for example: public pension plans (e.g., unions); vendors to municipalities (e.g., waste management); industries which depend on their local governments to provide essential services, such as reliable transportation infrastructure (e.g., Wall Street); and public safety (e.g., sporting events). On the long side, many entities, such as pension funds, might like to assume municipal credit exposure in exchange for a credit risk premium. However, municipal bonds, being tax advantaged, have little appeal to a tax exempt entity such as a pension fund. The MSX indices described herein allow the various constituents to seek risk transfer in the capital markets by providing an independently provided reference tool that is a key element of a trade to facilitate a transaction between two counterparties, the party seeking to hedge its exposure to a municipality's solvency and the party seeking to assume the solvency risk for a fee.

The MSX indices can include a family of indices that track the solvency positions of the largest state and local governments. In accordance with one or more embodiments, an index that tracks the largest 150 state and local governments is generated, and referred to herein as the “MSX150.” Sub-indices within the MSX150 can include, but are not limited to, those that track municipalities grouped by the following attributes:
Most solvent (MSXBLU)
Least solvent (MSXINS)
Most vulnerable to cash flow shortages (MSXFLO)
Most vulnerable to tax increases (MSXTAX)
Most vulnerable to service cuts (MSXSRV)
Most vulnerable pensions (MSXPEN)
Regional groupings (MSXRNE, MSXRSE, MSXRMW, MSXRNW, etc.)
States (MSXSTA)
Cities and Towns (MSXTWN)
Other material financial events (MFEs)
Individual municipalities
Broader indices, e.g. MSX250.

The indices allow interested parties to engage in transactions tied to the MSX index value that tracks changes in financial strength of individual municipalities, and that tracks likelihoods of financial events for a pre-defined grouping of municipalities (e.g., the largest 150) or for a customized grouping. The largest 150 state and local governments in the United States is just one example of the municipalities that can be included in an MSX index, and it should be understood that any combination or number of municipalities can be included in an MSX index or sub-index. In addition, the sub-indices above are intended to be examples of the types of attributes that can be tracked by exemplary embodiments, and it should be understood that other sub-indices based on other attribute(s) can also be generated.

In accordance with one or more embodiments, access to various MSX indices can be provided on a subscription basis. Indices and data analysis can be customized based on user requirements to provide predictions regarding items such as, but not limited to: municipal solvency, financial strength, and probabilities of material financial events (MFEs). Access to the customized data can be provided to the users using a distributed technology such as blockchain.

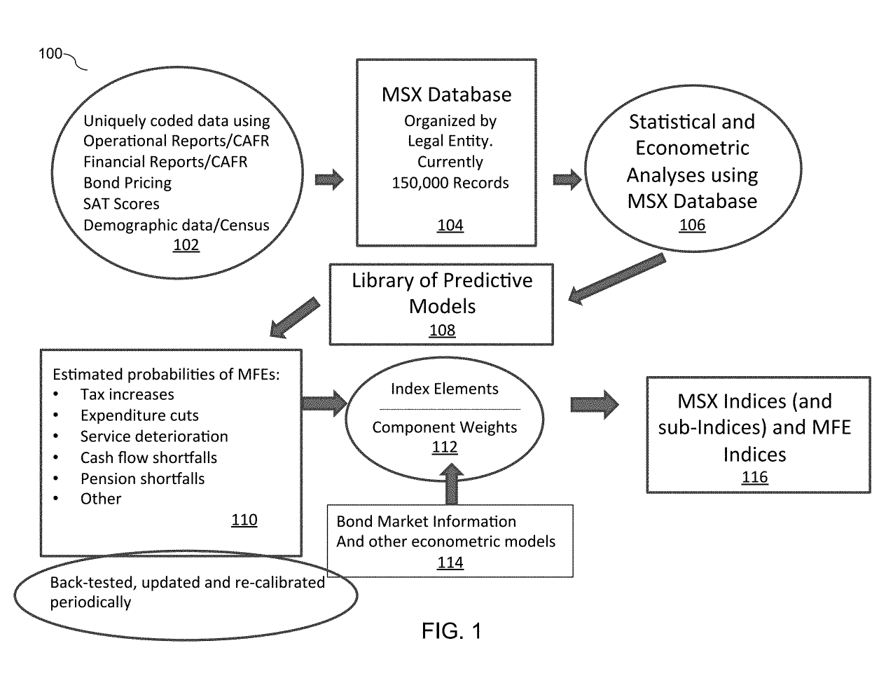

Turning now to FIG. 1, an overview of a process 100 for creating MSX indices is generally shown in accordance with one or more embodiments. The embodiment of the MSX database 104 shown in FIG. 1 has over 150,000 data elements (or variables) that are organized based on legal entity (e.g., government, business owned by the government). Information 102 that is compiled to create the contents of the MSX database 104 includes data from publicly available sources, such as, but not limited to: state and local Comprehensive Annual Financial Reports (CAFRs); demographic data from the Census; data from the Bureau of Economic Analysis; and bond pricing and bond market activity from the Municipal Securities Rulemaking Board (MSRB). In accordance with one or more embodiments, one thing that differentiates the data in the MSX database 104 is the comprehensiveness of the variables that are captured, and that each item in a municipality's financial statements from the CAFR is coded and then elements are recombined into meaningful economic and financial groups. In accordance with one or more embodiments, standard reporting classifications and standard legal entity structures are defined across municipalities in the MSX database 104, thus allowing financial statements of different formats and contents to be compared. This results in statistical and financial analyses that can yield more useful information and insight as to the leading indicators of material financial events when compared to contemporary approaches of analyzing this data.

At block 106, statistical and econometric analysis is performed on all or a subset of the data in the MSX database 104 to understand drivers of solvency and predictors of material financial events, such as tax increases, cuts to essential services, shortfalls in cash flow, and shortfalls in pension cash flow. The result of the analysis in block 106 includes one or more predictive models 108. In accordance with one or more embodiments, the predictive models 108 can provide insight as to the probability of material financial events (MFEs) in addition to the probability of default for certain municipal bonds. In accordance with one or more embodiments, various statistical models are employed to understand and derive the likelihood, or probability, of financial events such as those shown in block 110 of FIG. 1. As shown in block 110 of FIG. 1, MFEs can include, but are not limited to: tax increases; expenditure cuts; service deterioration; cash flow shortfalls; and pension shortfalls. The estimated probabilities of the MFEs shown in block 110 are derived based on the predictive models 108. The estimated probabilities shown in block 110 can be back-tested, updated, and re-calibrated periodically.

At block 112, index elements and component weights are derived based on the probabilities MFEs and econometric data 114 (e.g., bond market information and other econometric models). In accordance with one or more embodiments, when compiling the indices at block 112, additional statistical models which are used to weight the components of the indices are overlaid on the data in the MSX database 104. As shown in FIG. 1, MSX indices 116 including a MSX index and MSX sub-indices are generated. In accordance with embodiments described herein, statistical analysis of the solvency of a particular municipal entity is provided along with statistical analyses of MFEs for municipalities themselves.

Creation of MSX Database.

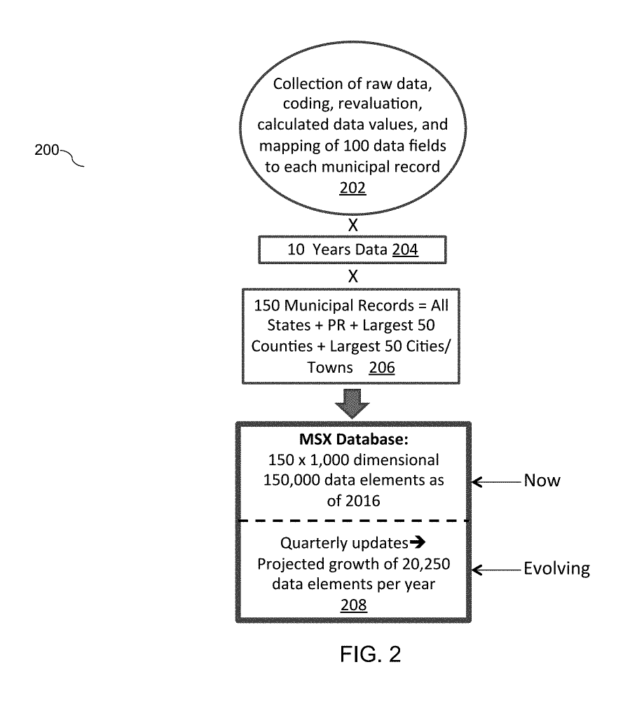

Turning now to FIG. 2, an overview 200 of contents of a MSX database, such as MSX database 104, is generally shown in accordance with one or more embodiments. As shown in block 202 of FIG. 2, raw data is collected from publicly available sources for each municipality tracked in the MSX database. Processing of the collected data can include coding, revaluation, calculating data values, and mapping data fields (e.g., 100 data fields) to each municipal record. As shown in block 204, in one or more embodiment data going back 10 years is collected. As shown in block 206, 10 years of data is kept for each of the municipalities in the MSX index (in this example 150). The 150 municipalities can include all 50 states in the United States, Puerto Rico, the largest 49 counties in the United States and the largest 49 cites/towns in the United States and Washington, D.C. The data for the 150 municipalities is stored in the MSX database as shown in block 208. In the embodiment shown in FIG. 2, the MSX database includes 150,000 data elements.

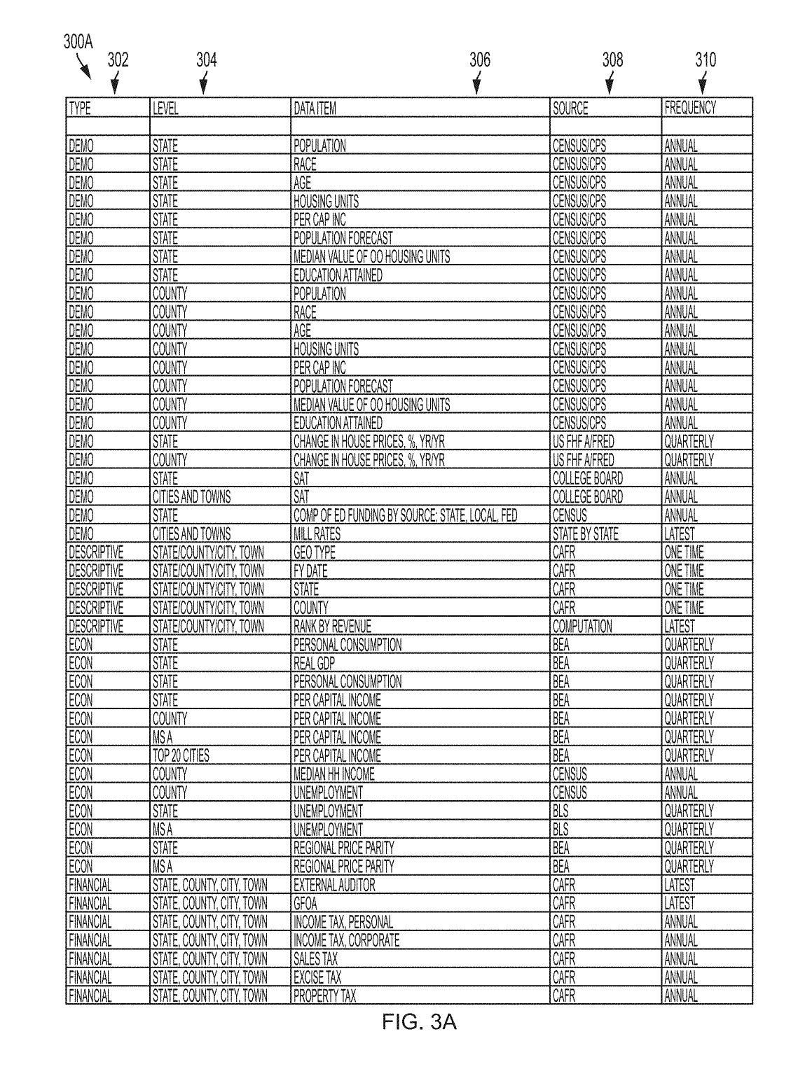

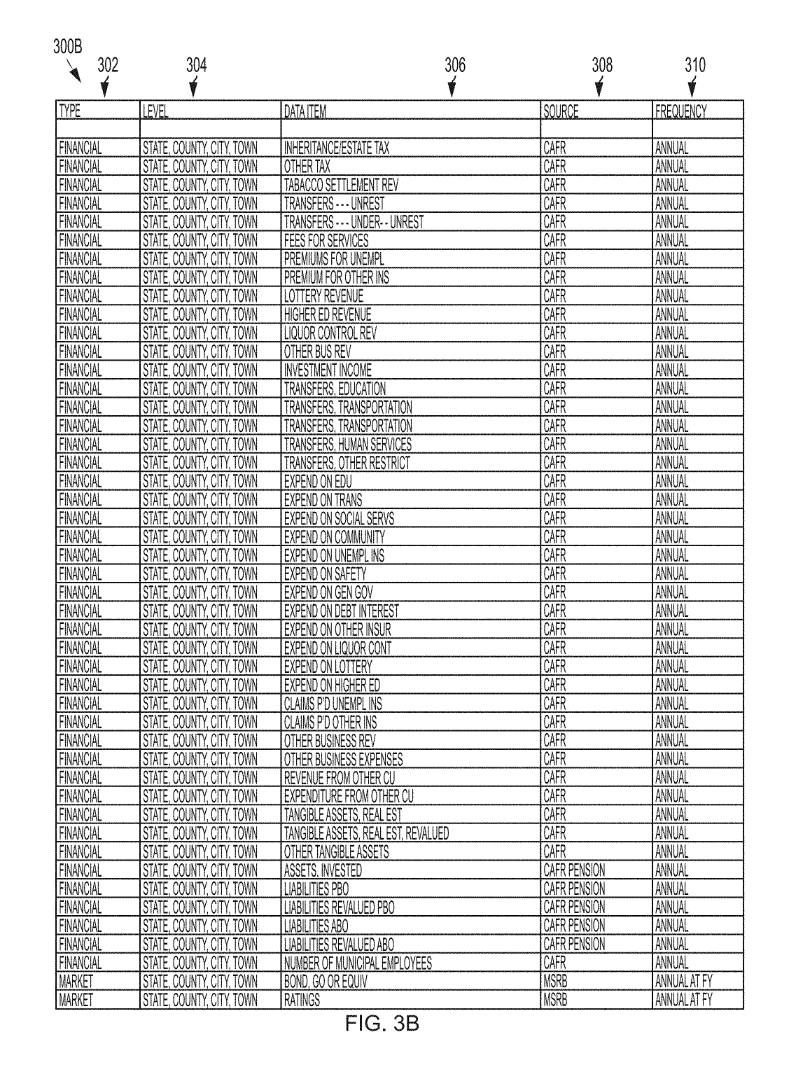

Turning now to FIG. 3A, a table 300A containing raw data that is used to generate a MSX database is generally shown in accordance with one or more embodiments. The table 300A includes a type column 302 for describing a type of the data (e.g., economic, financial); a level column 304 for describing the level at which the data are collected (e.g., state, county, top 20 cities); a data item column 306 for describing data item (e.g., population, SAT scores, sales tax); a source column 308 for describing the source of the data (e.g., CAFR, Census); and a frequency column 310 for describing how often the source of the data is updated (e.g., annual, quarterly). FIG. 3B also depicts a table 300B containing raw data that is used to generate a MSX database in accordance with one or more embodiments. Similar to table 300A, table 300B includes a type column 302; a level column 304; a data item column 306; a source column 308; and a frequency column 310. It will be appreciated that the tables and their contents shown in FIGS. 3A and 3B are exemplary in nature and that other table contents and configurations can be implemented by one or more other embodiments.

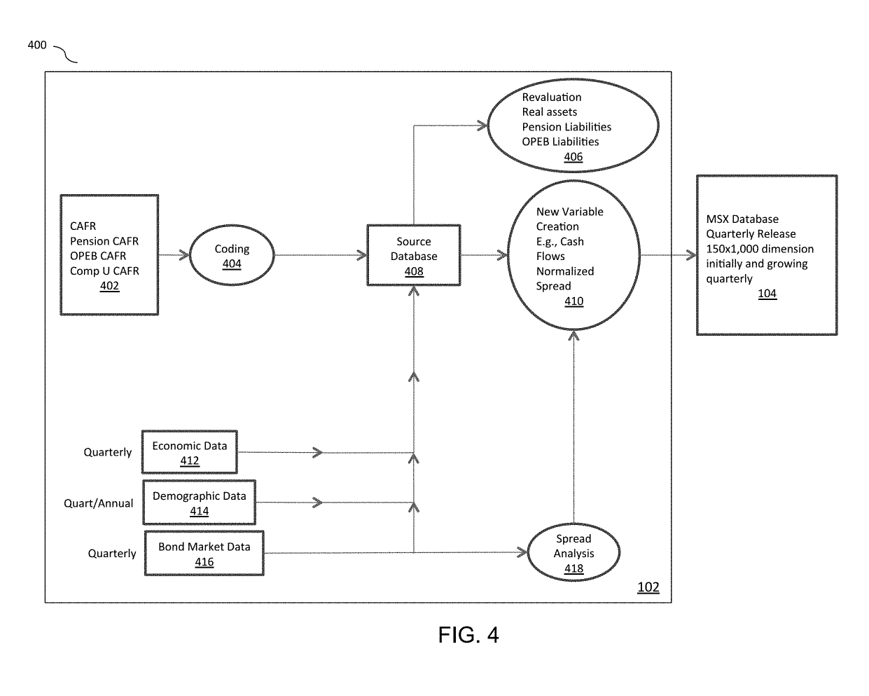

Turning now to FIG. 4, a data collection process 400 for generating contents of a MSX database, such as MSX database 104, is generally shown in accordance with one or more embodiments. As shown in the embodiment of FIG. 4, primary sources for the financial data can include CAFRs 402 for individual municipalities, such as a Pension CAFR, an Other Post Employment Benefit (OPEB) CAFR, and a Component Unit (Comp U) CAFR.

As shown in FIG. 4, coding 404 is applied to the data from the CAFRs 402. Each municipality is organized in a unique manner in terms of where the governmental and agency operations are organized by legal entity. The legal entity organization is the primary driver of how financial data are organized and reported. For example, some municipalities have higher education belonging to the primary government; others have higher education belonging to business enterprises that are owned by the government; and still other municipalities have higher education entities as a separate component unit, which is a separate legal entity that is not consolidated. In accordance with one or more embodiments, the data collected from the CAFR and other sources are codified to be independent of idiosyncratic legal organization. This allows identification of specific revenues, expenses, assets and liabilities associated with sources and uses of governmental, business entity, and component entity funds, and thus being able to more effectively make comparisons across municipalities. In one example, the goal is to identify spending on higher education, regardless of how the municipality is legally organized. In accordance with one or more embodiments, assets and liabilities are collected from both a Statement of Activities (income statement) and a Statement of Position (balance sheet) and assigned unique codes.

Referring back to FIG. 4, at block 406, in accordance with one or more embodiments, some balance sheet items, such as real assets (e.g., real estate), are revalued. Data can be collected from state and local pension funds, which are separate legal entities from the primary government, and have their own CAFRs. Pension liabilities, both the projected benefit obligations (PBOs) and the accrued benefit obligation (ABOs) can be revalued, as well as the OPEB liabilities.

As shown in FIG. 4, bond market data 416, which is an example of financial data, are collected from sources outside of municipal reporting entities. In accordance with one or more embodiments, data is collected from external sources, such as the Municipal Securities Rulemaking Board (MSRB), to complete the financial picture for each municipality, for example, on debt outstanding for each municipality. Again, because of the legal entity structure of each municipality, the general government balance sheets do not report obligations of component units (e.g. agencies). Full disclosure and reporting of the component units are not reported in a municipality's CAFR. For example, in the mid-2010s the New York State CAFR reported approximately $3.5 billion in debt outstanding, when the total debt outstanding of all New York state enterprises and component units was closer to $90 billion. Also as shown in FIG. 4, a spread analysis 418 can be performed on the bond market data before it is used for new variable creation 410. An analysis of the drivers of spreads provides an indication of what the market values as having the most relative influence of the credit riskiness of the municipal bonds. The spread analysis in turn is used to weight the component scores of the MFEs into a composite solvency score for each municipality. Demographic data 414 and economic data 412 are also collected from a variety of sources, such as but not limited to: The United States Census Bureau, The Federal Housing Authority, The Bureau of Economic Analysis, and The Federal Reserve. Not all data are collected for cities, towns, counties and states, thus the data can be mapped to the most precise region. For example, for demographic data available by metropolitan statistical area (MSA), a mapping of cities, towns, and counties is performed to the relevant MSA. For data available only by state, the state level information is entered for cities and counties residing in the state.

From the data collected, one or more embodiments can be utilized to perform new variable creation 410. New variables can be created such as, but not limited to, cash flow (CAFRs do not report a Statement of Cash Flow), tangible surplus (total tangible assets minus total liabilities). In addition, projections of certain variables such as gross domestic product (GDP) and income can be performed, as well as projections for certain cash flow items such as net pension benefits.

The result of the collection, codification, revaluation, mapping and calculations is a comprehensive longitudinal and cross sectional (panel dataset) MSX database 104 that is uniquely compiled, allowing one or more embodiments to perform statistical analysis on the financial strength of each municipality. In one or more embodiments, each municipality has over 1,000 data fields (e.g., 100 data fields for each year) in the MSX database 104. In one or more embodiments, an initial data set has 150 records (largest 150 municipalities) yielding a dataset dimension of 150 records×1,000 or 150,000 elements. The number of data fields increases each quarter, since some data are updated quarterly, and with each reporting year.

The source database 408 shown in FIG. 4 includes core raw data from CAFRs uniquely coded and inputted, and external data such as economic data 412, demographic data 414, and bond market data 416. The new variable creation 410 is an intermediate work product and the MSX database 104 includes the quarterly release of final values (“variables”) that get used as direct inputs into scores etc.

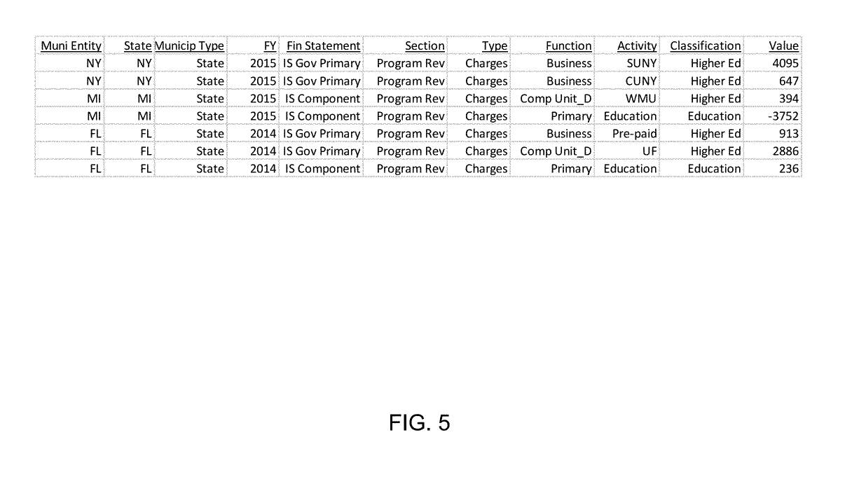

Turning now to FIG. 5, contents of a MSX database, such as MSX database 104, are generally shown in accordance with one or more embodiments. As described previously, each data item from the relevant CAFR statement (primary government, fiduciary, or component unit) is coded individually at a granular level. Data across multiple financial statements in the government CAFR and across sub-CAFRS (e.g., pension fund CAFRs) is collected and brought into one database, and coded to allow for easier analysis of financial condition.

For example, as shown in FIG. 5, for Michigan, fees charged for higher education are captured by where the value is reported (e.g., income statement for component units), where it appears within the statement (e.g., a program revenue item), the type of inflow or outflow (e.g., fees charged for services), the legal entity (e.g., a discretely presented component unit), the activity (Western Michigan University), and then a classification within the MSX database (e.g., higher education). In this way, all higher education expenses associated with a municipality can be captured and compared regardless of how the municipality is organized.

In contrast, if the analysis was restricted to primary government activity and the basic financial statements of the government (primary+business), fees charged with higher education in Michigan would not be captured and a comparison between Michigan's and New York's fees charged for higher education would be misleading.

Capturing and coding data in this way also results in a broader picture of fees charged across all types of education programs. For example, as shown in FIG. 5, in Florida the primary function education is essentially K-12 and fees for this are 236 million dollars, and higher education fees charged are 2.9 billion dollars, and fees charged for the state's college savings program are 913 million dollars. One or more embodiments can not only compare college savings programs across states using the MSX database, but also total fees collected for all educational programs, including pre-paid fees.

Predictive Models.

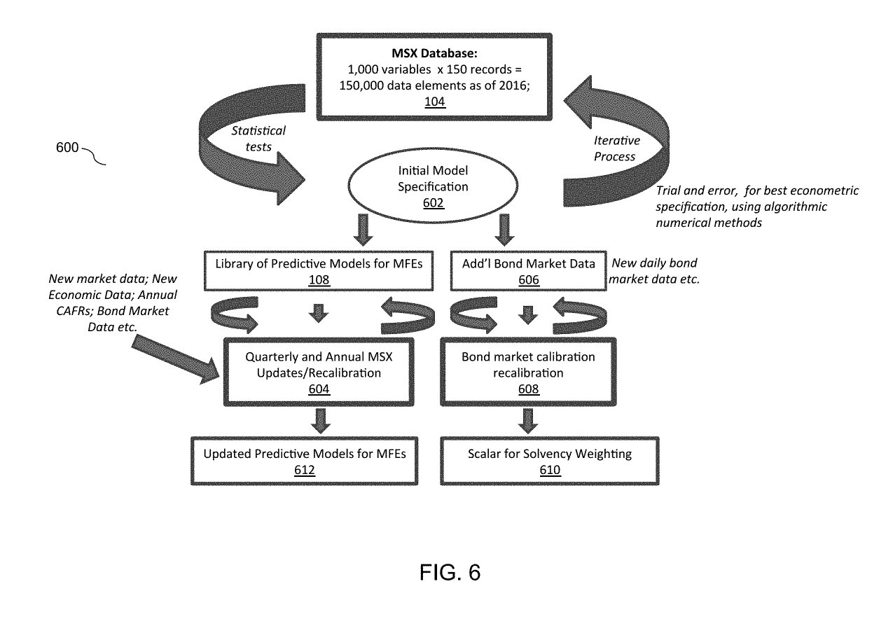

Turning now to FIG. 6, an overview of a process 600 for generating predictive models, such as predictive models 108, is generally shown in accordance with one or more embodiments. In accordance with one or more embodiments, a combination of statistical and econometric techniques are employed to produce predictive models for each municipality's probability of certain MFEs such as, but not limited to: tax increases, expenditure cuts, service deterioration, cash flow shortfalls, and pension shortfalls. The contents of the predictive models 108 can be modified/updated based, for example, on information from experienced econometricians working together with its public finance economists who understand the dynamics of tax and spending policies, demographic movements, and regional economic growth.

In accordance with an embodiment, the MSX database 104 has 1,000 variables and is expected to grow by over 200 variables per year with quarterly and annual updates. Thus, the number of possible combinations of the 1,000 variables that can be used in a predictive model to estimate probabilities for the MFEs are practically uncountable (for example, the number of possible combinations of 1,000 variables is more than 2.6e+157 (2.6 times 10̂157, i.e., a number with 157 zeros), which is in excess of the capability of most computers, especially when the data would need to be manipulated, requiring even more computational capacity.

Embodiments described herein use an iterative approach where various statistical models are specified and then statistically tested to measure how well they explain observed data and how well they predict MFEs on a back-tested basis. These statistical models are shown in FIG. 6 as initial model specification 602. In accordance with one or more embodiments, models selected to predict MFEs utilize various methods, and may involve stochastic processes and auto-regressive features, among others. Once a basic model specification is determined, fine tuning can performed based on testing statistics, using both algorithmic numerical methods and professional discretion in a trial-and-error approach to find the specification of the model that yields “best fit.” Best fit is determined statistically by finding a “model specification,” which is a selection of key explanatory variables, both contemporaneous and lagged, that taken together are the best predictors of MFEs. Best fit models are also characterized by having robust (stable) and statistically significant model parameters and which will predict MFEs with high explanatory power without systematic errors. As shown in FIG. 6, predictive models 108 are created based on the initial model specification 602.

In accordance with one or more embodiments, the selection of the key variables can be based on statistical metrics selected by analysts (e.g., econometricians, public finance economists, etc.) as being likely to yield the best model specification. Various tools can be used to choose the testing parameters that measure “best fit,” while knowing which variables and combinations of variables to trial that are likely to yield good parametric results is a function of the experience of the analysts and the trial and error process. The key variables can change over time based on current economic conditions. As shown in FIG. 6, the predictive models 108 are re-calibrated 604 with the release of new quarterly data and to create updated predictive models for MFEs 612. The new quarterly (and yearly) data are inputted into the specified predictive model (e.g., one of the predictive models 108) to generate revised parameter estimates for explanatory variables.

In accordance with one or more embodiments, a scalar for solvency weighting 610 is developed using bond market data 606 to fine tune the predictive models 108 that can be based largely on historical patterns and on CAFRs that represent a municipality's financial position that is not current. Bond market data 606 are available daily, and pricing, liquidity, volume and other data are statistically analyzed to gather additional, stand-alone explanatory power that may reflect the market's current views on certain municipalities. In accordance with one or more embodiments, bond market information is calibrated/recalibrated 608 to generate a scalar for solvency weighting 610. The updated predictive models for MFEs 612 along with the scalar for solvency weighting 610 are used to create MFE and MSX indices in accordance with one or more embodiments.

Example of Generating Predictive Models.

In accordance with one or more embodiments all descriptive statistics are calculated and public finance trends are analyzed by an analyst (e.g., an econometrician and/or a public finance economist) by type of municipality, size, geographic location, etc. This helps to understand the data to make informed modeling choices. For example, the overall history of tax increases across states is analyzed. Do states raise taxes every year? Often? By how much? The analyst collects data to understand a materiality threshold and the frequency distribution of tax increases by size.

The setting of the materiality threshold is the first stage in the creation of the predictive models. The models are designed to predict the probability of a municipality breaching a threshold of a given variable. For example, the models do not predict the probability of simply an increase in taxes, but rather an increase in taxes of a certain magnitude. The certain magnitude is the threshold that is established by evaluating the data historically and determining what has constituted a material change. The thresholds are likely, but not necessarily, to be established based on a uniform convention, such as one standard deviation of an historical mean.

Next, the analyst can analyze data to understand what causes income tax rates to materially increase in states. This can be performed by running a variety of regressions including various explanatory variables, trialing with adding in and subtracting out variables of the regression and trying assorted combinations. In one or more embodiments, the following is evaluated:

Changes in income tax rates=b₀+b₁*Net Income Marginₜ₋₁+b₂*Net Income Marginₜ₋₂+b₃*Elapsed years since last tax increase+b₄*%D(population)ₜ₋₁+b₅*%D(population)ₜ₋₂,
where D signifies change; t−1, t−2, etc. signify the time period associated with the variable; and b0, b1 etc. signify the parameter weight for the variable.
   The regression output can be evaluated, resulting in finding that R² (a measure of goodness of fit) is low and the t-statistic (a measure of the statistical significance of the explanatory variable) for the estimated b₄ is too low, and thus this specification would be rejected.

Several hundred specifications (combinations of variables on the right hand side of the equation) can be run that have been pre-selected by having evaluated the descriptive statistics and the results of prior specifications that were trialed. The candidate specifications can be narrowed down to a small group for best model specification. From there, additional tests of goodness of fit and significance are run (illustration below) and the analysis can arrive at the following model which best describes how state income taxes are affected:

Changes in income tax rates=b₀+b₁*Net Income Marginₜ₋₁+b₂*Net Income Marginₜ₋₂+b₃*(Moving 4 year Average of Population Growth)+b₄*%D(Personal Income/Municipal Employeesₜ).
Estimated parameters and their t-statistics in parentheses:
b₀=0.014 (1.53)
b₁=−0.121 (−2.50)
b₂=−0.085 (−2.02)
b₃=0.056 (3.34)
b₄=−0.022 (−1.92)

This initial model specification 602 can provide insight into what drives changes in tax rates. The initial model specification 602 provides a baseline model and a reference point for developing predictive models 108 to estimate what drives the probabilities of MFEs, and allows flexibility in updating predictive models if materiality thresholds change.

In accordance with one or more embodiments, the initial model specification 602 includes a set of well-specified econometric models that describe relationships among public finance, operational, demographic, economic, and market data as well as models that are used as baseline models for predicting MFEs. The term “well-specified” means that the models have high predictive capability, do not over or under predict systematically, have explanatory variables that are statistically significant and that have a high degree of independence from each other, and that exhibit parsimony, meaning using the smallest amount of variables as needed.

The models are back-tested quarterly as new data become available (e.g., the existing model's predictive ability of tax changes is tracked). When new quarterly and annual data are available, regressions are rerun to update parameter estimates. If the predictive model shows a pattern of either systematically under or over predicting tax increases or if the gap between actuals and predicted values widens, a new model specification is created following the procedure outlined above.

In accordance with one or more embodiments, the predictive models 108 become a library of econometric models that describe (i) the structural relationships (i.e. causal) between demographics, economics etc., and municipal finances, and (ii) the “reduced form” relationships (i.e. empirically related without regard to structure or causality) across financial, economic, demographic variables. This can provide a good understanding of how variables relate to each other and what drives changes in particular variables of interest, e.g., municipal finance, demographic, and economic. Examples of predictive models in the library include, but are not limited to: change in population growth in a city; change in expenditures on health care; change in personal income in a state; and net income margin growth for counties.

The predictive models 108 can also provide insight on the order of how municipalities react and adjust to financial challenges. For example, a state's first line of defense may be to stop funding the pension plans. Then, a state may raise fees on services to close a cash shortfall until such time as the market will no longer bear fee increases. It then may raise taxes until tax headroom is exhausted (politically infeasible to continue to raise taxes). Cuts to essential services may follow only once the other mechanisms have been utilized fully. Therefore, knowing what mechanisms a state has utilized can be used as prior information in the model specification (i.e., the assessment of the probability). Thus, embodiments of the modeling described herein allow generation of the probabilities of MFEs conditional on prior events having occurred, such as recent and large sales tax increases.

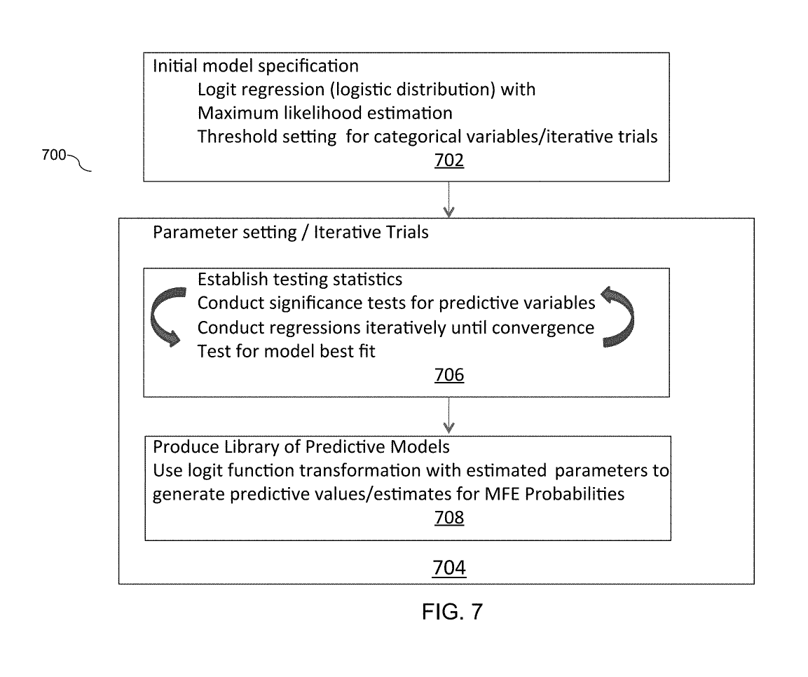

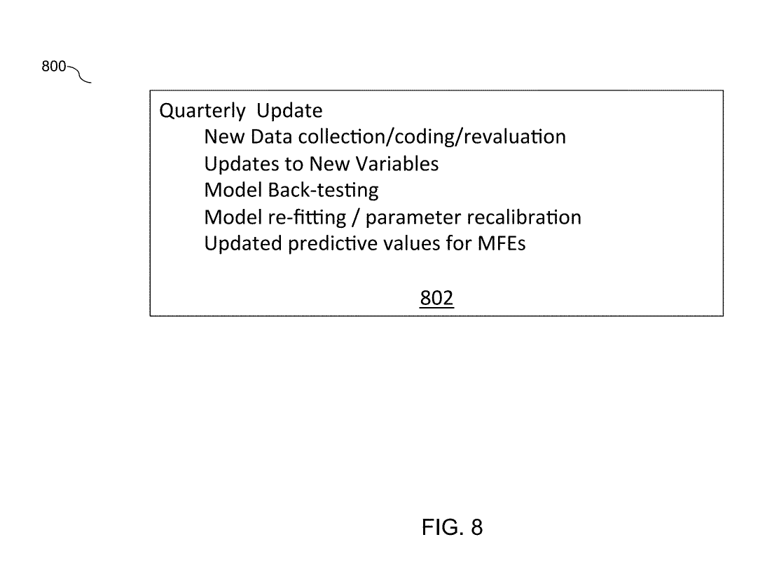

Turning now to FIG. 7, a process 700 for creating an initial model specification, such as initial model specification 602, and predictive models, such as predictive models 108, is generally shown in accordance with one or more embodiments. As shown in block 702, the initial model specification can be generated by utilizing logit regression (logistical distribution) with maximum likelihood estimation and threshold setting for categorical variables/iterative trials. As shown in block 704, predictive models are generated by performing parameter setting using iterative trails. An embodiment of processes that can be used to establish testing statistics is shown in block 706 and an embodiment of a process that can be used to produce predictive models is shown in block 708. Turning now to FIG. 8, a process 800 for performing a quarterly update 802 is generally shown in accordance with one or more embodiments.

Probability Estimates.

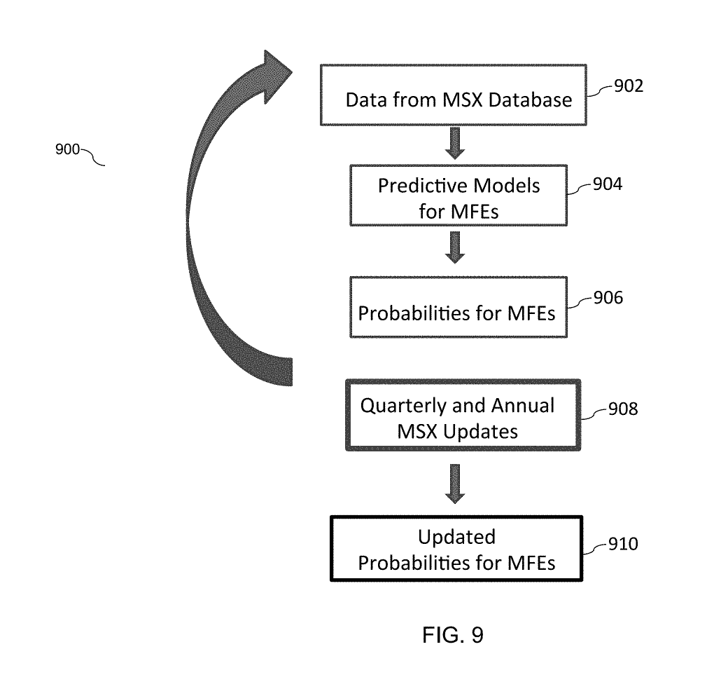

Turning now to FIG. 9, a process 900 for estimating probabilities of MFEs is generally shown in accordance with one or more embodiments. As shown in blocks 902-906 of FIG. 9, data from an MSX database, such as MSX database 104, is used to create predictive models for MFEs, such as predictive models 108, and the predictive models are used to generate probabilities of MFEs. As shown in blocks 908-910 of FIG. 9, the quarterly and annual MSX updates are applied to the MSX database and also used to update probabilities for MFEs. As shown in the embodiment of FIG. 9, the update to the probabilities for MFEs shown in block 910 is independent of the re-calibration of the predictive models in block 904. Parameters in the predictive models may or may not be recalibrated with quarterly new data; but new quarterly data will generate revised probabilities of MFEs.

For example, it may be desired to put the relationship between tax increases and their drivers into context. Establishing the context requires a determination of the materiality threshold. If all states raise taxes half of one percent every year, that statistic is simply a trend that doesn't need to be predicted since it will likely happen. Instead, one or more embodiments are looking for the chance that a state might raise taxes in a material way that would matter to residents and businesses. Based on an understanding of public finances for a sector/size/geographic location and an analysis of the data, analysts can define the materiality thresholds for the MFEs. For example, a materiality threshold for state income tax increases may be determined to be one percentage point.

Once an initial model specification, such as initial model specification 602, is created and the thresholds set, logistical regression can be employed to assess the probability of an MFE. In the state income tax example, all state income tax changes can be converted into categories based on the threshold. Thus, if the actual tax increase>1% point, then Y=1; otherwise Y=0. Regression can be run using ordinary least squares (OLS) methods based on the initial model specifications with modifications. The modifications can include adding or subtracting explanatory variables based on the threshold setting and due to the fact that the dependent variable has now been converted to a binary variable [0 or 1]. This can result in a revised specification of:

Tax increases exceeding a 1% pt threshold=b₀+b₁*Net Income Marginₜ₋₁+b₂*Net Income Marginₜ₋₂+b₃*(Moving 6-year Average of Population Growth)+b₄*(Revenue per Municipal Employeeₜ)+b₅*(Fee Revenue as % of Total Tax Revenue).
Estimated parameters and their t-statistics in parentheses:
b₀=1.00 (1.74)
b₁=−4.20 (−2.62)
b₂=−1.61 (−2.55)
b₃=4.10 (2.60)
b₄=−2.20 (−1.98)
b₅=−1.77 (−2.99)

The model is evaluated based on the same criteria as before (e.g., goodness of fit such as R², likelihood ratios, statistical significance of chosen explanatory variables, Wald or other statistics). With estimates of the beta parameters, the probability of a tax increase can be estimated given values of the explanatory variables by converting the predicted tax increase dependent variable using a Logit transformation.

The estimated values of Y are calculated using the estimated parameters and actual data for the states.

For example, given two states with the following 2006 data, an estimated Y is calculated for each state and then converted into a probability using a logit transformation:

Estimated P(tax increase)=1/1+exp̂−(estimated Y)

Thus, State 1 has a 14% chance of a tax increase of 1% or more in 2006 and State 2 has a 27% chance of a tax increase of 1% or more in 2006.

Once the estimated probabilities are obtained, one or more embodiments check again for goodness of fit using a variety of methods. For example, the actual occurrence of tax increases greater than the threshold can be plotted against the predicted values of that happening for each state and then observed for points falling close to the 45° line.

If analysts are unsatisfied with how the model performs with generating predictive probabilities, based on a combination of goodness of fit tests or if results are counter-intuitive, the chosen parameters can then be re-estimated using a maximum likelihood method (MLE) which finds the values for the b0, b1 . . . b5 parameters using a trial-and-error numerical method, such as Newton Raphson, in which a search is made for estimated values of the b parameters that generate a predicted value for the probability that is consistent with actual occurrences of taxes increasing by the threshold amount.

Creating MSX Indices.

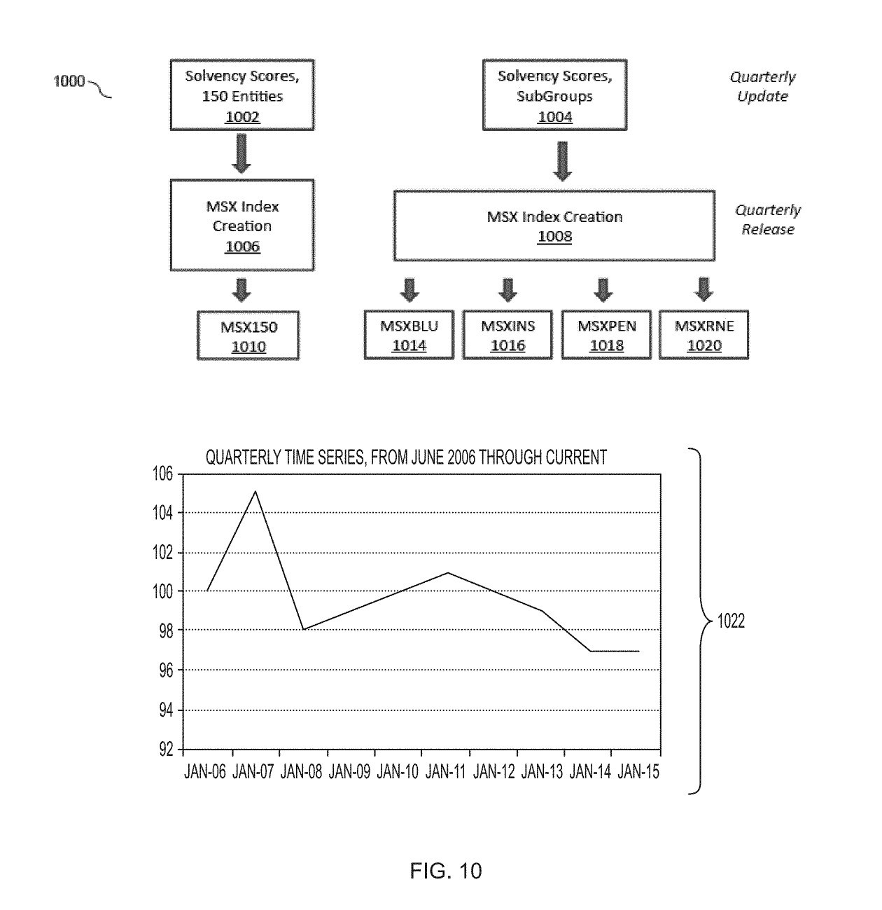

Turning now to FIG. 10, a process 1000 for generating MSX indices is generally shown in accordance with one or more embodiments. The embodiment shown in FIG. 10 generates the MSX150 index 1010 and sub-indices 1014, 1016, 1018, 1020; however it should be appreciated that the processing described herein can be applied to the creation of any MSX indices and sub-indices. As shown in FIG. 10, solvency scores for the 150 municipalities 1002 are input to MSX index creation 1006 to produce the MSX150 index 1010. Also as shown in FIG. 10, solvency scores for selected subgroups 1004 are input to MSX index creation 1008 (which can be the same as MSX index creation 1006) to produce the MSX sub-indices 1014, 1016, 1018, 1020. The indices can be updated quarterly and displayed as a quarterly time series, for example a graph 1022 from June 2006 through current.

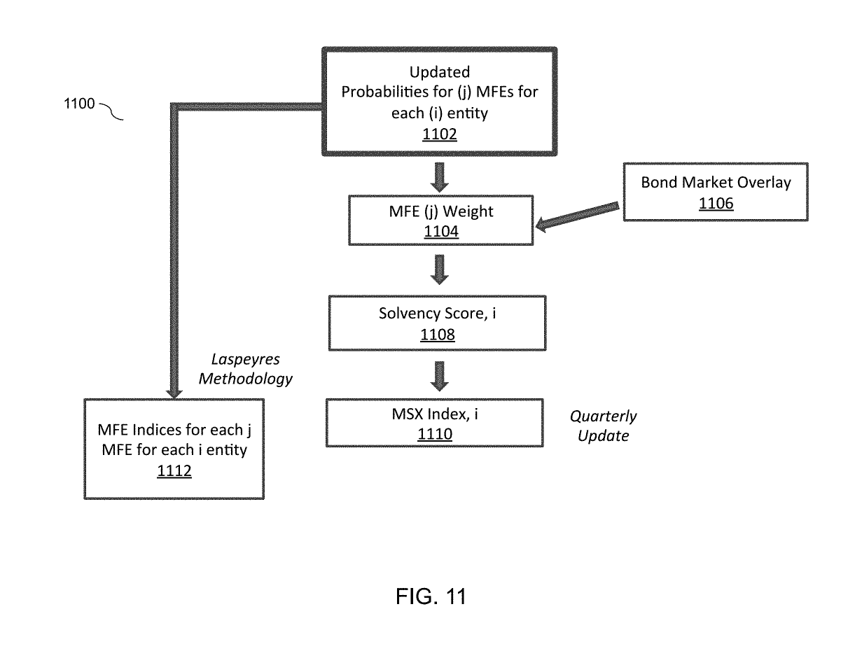

Turning now to FIG. 11, a process 1100 for producing MSX and MFE indices for a single entity is generally shown in accordance with one or more embodiments. As shown in FIG. 11, updated probabilities for (j) MFEs for each (i) entity 1102 are input along with bond market overlay data 1106 to generate MFE weights 1104 for each of the (j) MFEs. The MFE weights 1104 are used to generate a solvency score 1108 for each of the (i) entities. The solvency score 1108 for each entity is used to generate MSX indices 1110 for each of the entities. Also as shown in FIG. 11, the updated probabilities for (j) MFEs for each (i) entity 1102 are also input to generating (e.g., using a Laspeyres methodology) MFE indices 1112 for each (j) MFE for each (i) entity. In accordance with one or more embodiments, the MSX indices 1110 and MFE indices 1112 are updated quarterly.

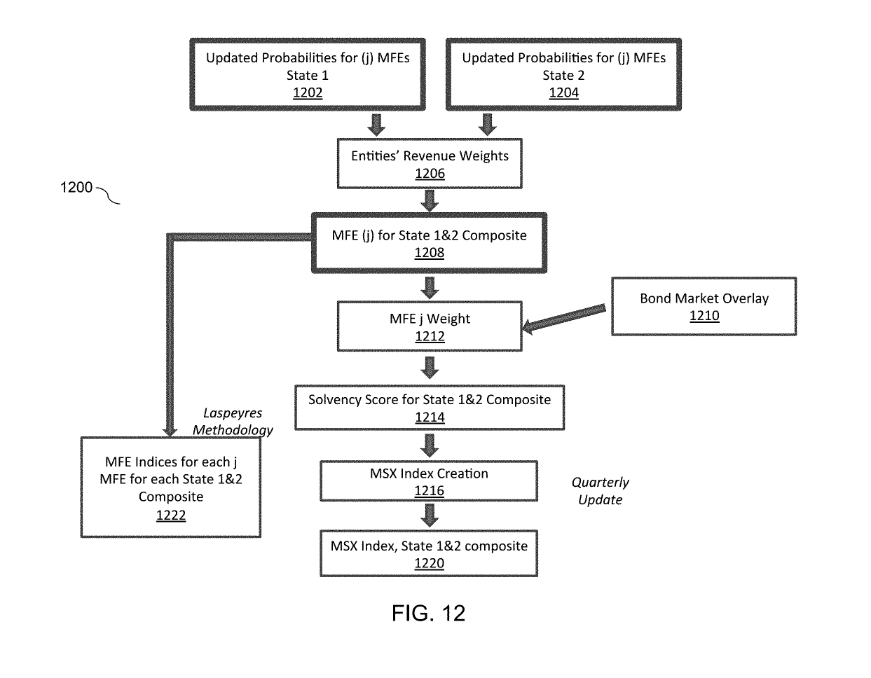

Turning now to FIG. 12, a process 1200 for producing composite MSX and MFE indices is generally shown in accordance with one or more embodiments using states as examples of municipalities. As shown in FIG. 12, updated probabilities for (j) MFEs for state 1 1202 and updated probabilities for (j) MFEs for state 2 1204 are input along with revenue weights for the entities 1206, or municipalities, to generate composite MFEs 1208 for states 1 and 2. The composite MFEs 1208 are input along with bond market overlay data 1210 to generate composite MFE weights 1212 for each of the (j) MFEs. The composite MFE weights 1212 are used to generate a solvency score 1214 for the state 1 and state 2 composite. The solvency score 1214 is used at block 1216 to generate a composite MSX index 1220 for state 1 and state 2. Also as shown in FIG. 12, the composite MFEs 1208 for states 1 and 2 are also input to generating (e.g., using a Laspeyres methodology) MFE indices 1222 for each (j) composite MFE 1208 for states 1 and 2. In accordance with one or more embodiments, the MSX index 1220 and the MFE indices 1222 are updated quarterly.

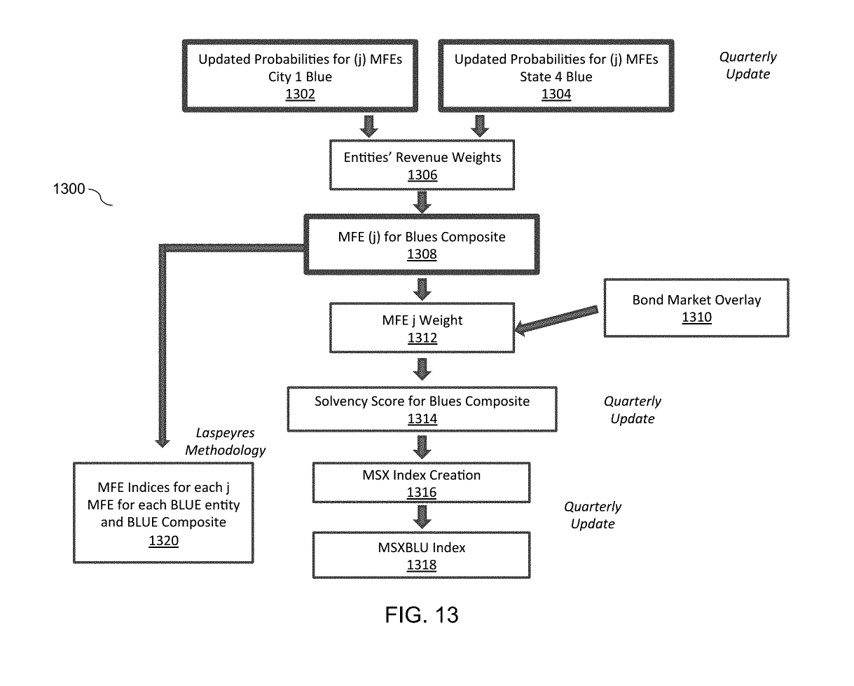

Turning now to FIG. 13, a process 1300 for producing MSX and MFE indices for BLUE components is generally shown in accordance with one or more embodiments. As used herein, the term BLU, or BLUE, refers to the grouping of municipalities that have the highest solvency scores (e.g., top 5%, top 10%, top 20%). As shown in FIG. 13, updated probabilities for (j) MFEs for city 1 blue 1302 (where city 1 blue refers to a city that is in the BLU subgroup) and updated probabilities for (j) MFEs for state 4 blue 1304 (where state 4 blue refers to a state that is in the BLU subgroup) are input along with revenue weights for the entities 1306 to generate composite MFEs 1308 for city 1 blue and state 4 blue. The composite MFEs 1308 are input along with bond market overlay data 1310 to generate composite MFE weights 1312 for each of the (j) MFEs. The composite MFE weights 1312 are used to generate a solvency score 1314 for the city 1 blue and state 4 blue composite. The solvency score 1314 is used at block 1316 to generate a composite MSXBLU index 1318 for city 1 blue and state 4 blue. Also as shown in FIG. 13, the composite MFEs 1308 are also input to generating (e.g., using a Laspeyres methodology) MFE indices 1320 for each (j) composite MFE 1308. In accordance with one or more embodiments, the MSXBLU index 1318 and the MFE indices 1320 are updated quarterly. Embodiments are not limited to particular subgroups, as other subgroups, such as, but not limited to a group of the top bond issuers (e.g., top 5%, 10%, 20%) can be created. A composite MSX solvency index such as MSXTOP can be generated to reflect the group of top bond issuers as well as associated MSXTOP sub-indices and MFE indices.

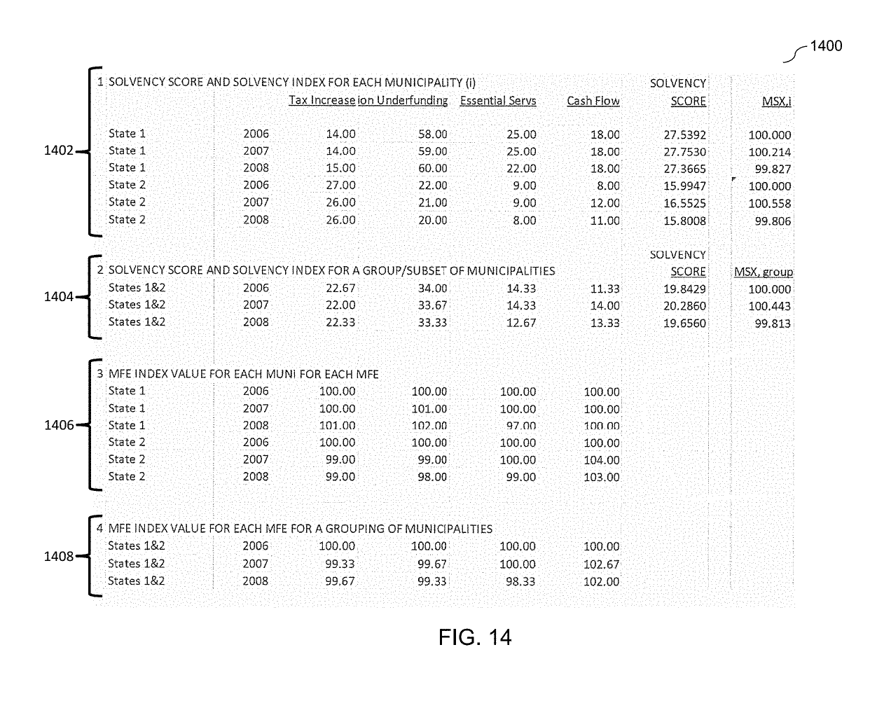

Turning now to FIG. 14 an example 1400 of producing MSX and MFE indices is generally shown in accordance with one or more embodiments.

Combining MFE Scores into a Solvency Score for each Municipality 1402

Each municipality's probabilities of MFEs can be compiled to form a solvency score. This compilation is based on data analyses of the municipal bond market, even if the municipality does not issue municipal bonds. As shown in 1402, the MFEs include but are not limited to tax increases, pension underfunding, and essential service cutbacks, and the table includes the probability of each of these MFEs for State 1 and State 2 in years 2006, 2007, and 2008. The solvency score can be calculated for each year and state as the sum of each MFE probability times a weight of the MFE. The MSXi shown in FIG. 14 is calculated using 2006 as the base year, and thus the MSX score in 2006 for both states is 100.

In accordance with one or more embodiments, the MSX is compiled by aggregating two groups of data, first, a solvency score is compiled for each municipality, which is based on compiling the probabilities of MFEs for each municipality. Next, both the MFEs and the solvency scores are compiled across municipal entities.

The following text describes a method of compiling a solvency score for a municipality in accordance with one or more embodiments. The example creates the solvency score for “State 1” and a similar approach would be applied to each municipality in the index.

In this example, State 1's MFE probabilities are as follows:
Prob (Tax Increase of >1% point)=0.14
Prob (Pension Underfunding rising by>5%)=0.58
Prob (Cuts to Essential Services>5%)=0.25
Prob (Cash Flow, upcoming year<0)=0.18

These four MFEs are aggregated into State 1's Solvency Score by weighting each component and then aggregating them into one compiled score. Information from the bond market is used to create weights, since bond prices are reflections of the capital market's compiled outlooks, and thus reflective of all knowable information. In accordance with one or more embodiments, variables are discovered and their parameters estimated in explaining bond market pricing.

In accordance with one or more embodiments, bond market pricing is regressed on the MFEs as independent variables. In the case of states, all bond market pricing data from 2006-2015, for general obligations, without credit enhancement, call features, or pre-refunding can be regressed against the MFEs for municipalities that have outstanding general obligations bonds, as described above, on a contemporaneous basis. Spreads (yields net of contemporaneous treasury yields for the same tenor) can be regressed against tax increases, pension underfunded levels, reductions in essential services and cash flow of the total government account, for each bond for which pricing data is available. This may include 300 to 400 observations (bond pricing data that are within one week of the release of the annual CAFR can be selected). The regression yields parameter estimates of the explanatory power that each MFE plays in driving bond yields across the bond market, and not specific to any particular municipality. Parameter estimates and corresponding t statistics can look like the following:
Changes in bond spreads=
b₀=0.01 (1.53)
b₁=−0.172 (−1.87) (tax increase)
b₂=0.255 (1.61) (pension underfunding)
b₃=0.402 (2.13) (reduction in essential services)
b₄=−0.699 (−1.92) (negative cash flow of the general account)

The absolute values of the t-statistics are used as weights for the MFE probabilities to compile a solvency score. T-stats can be used because they reflect not only the absolute size of the parameter weight but are then normalized by the standard error, to produce a relative weight. A larger relative weight (t-stat) will have a larger parameter estimate, a smaller standard error, or both.

If the probabilities for State 1 are the following:
probability of a tax increase>5% in the next year=0.14
probability of pension underfunding rising by>5% points in the next year=0.58
probability of reduction in essential services>5%=0.25
probability of negative cash flow of the general account=0.18

The solvency score for State 1 can be calculated as:

$$\frac{( 1.87 \times .14 + 1.61 \times .58 + 2.13 \times 1.92 \times .18 )}{( 1.87 + 1.61 + 2.13 + 1.92 )} = 2.07 / 7.53 \times 100 = .2754 \times 100 = 27.539 .$$

The value of 27.539 has a loose interpretation of the State having a 27.5% probability, on average, of experiencing one or more MFEs in the next year. The score for State 1 can be calculated for each time period. This allows tracking the score over time to gauge if the State's 1 year forward looking likelihood of experiencing an MFE has risen or fallen over a period. Tracking can be done either with the raw Solvency Score or by converting the Solvency Score into an Index value (described below).

Another example of calculating a solvency score for a state, “State 2” follows. If the probabilities for State 2 in 2006 are:
Probability of a tax increase>5% in the next year=0.27
Probability of pension underfunding rising by>5% points in the next year=0.22
Probability of reduction in essential services>5%=0.09
Probability of negative cash flow of the general account=0.08

The solvency score for State 2 can be calculated as:

$$1.87 \times .27 + 1.61 \times .22 + 2.13 \times .09 + 1.92 \times .08 = / ( 1.87 + 1.61 + 2.13 + 1.92 ) = 1.20 / 7.53 \times 100 = .1599 \times 100 = 15.99 .$$

Creating composite MFEs and Solvency Scores for a group of municipalities 1404

As shown in 1404, the MFEs are composite MFEs which reflect the probability of each of the MFEs for the combination of (i) entities, in this case 2 entities—State 1 and State 2 in years 2006, 2007, and 2008. The composite MFEs can be calculated by summing: the probability of each MFE individually multiplied by the revenue weight of the MFE. A composite solvency score can be calculated for each year and combination of (i) entities as the sum of each composite MFE probability times a weight of the MFE. When calculating the MSX150 index described herein, (i) would be equal to 150.

Municipalities can be grouped together and their individual MFEs complied into an aggregate MFE. The compilations are made based on revenue weights during the base period, which is 2006. As in FIG. 14, State 1 has a 14% probability of a 5% or greater tax increase and State 2 has a 27% probability, and the combined probability is simply a weighted average of the two probabilities with each state's revenue used to weight the probabilities (33% and 67%, respectively), for a combined score of 22.67.

Each municipality's solvency score can be aggregated into a group solvency score by weighting each municipality's solvency score by its revenue weight as of the base period. As in FIG. 11, State 1's solvency score in 2007 is 27.753 and State 2's is 28.659 and the combined Solvency Score for the grouping (State 1 and State 2) is 28.357 based on revenue weights of 33% and 67% respectively.

Creating MFE Indices for a Municipality 1406

As shown in 1406 of FIG. 14, MFE indices are created for each entity. The probability of each MFE is used to create the index value.

In accordance with one or more embodiments, the index values are created using 2006 as a base year. Each municipality has a score for each MFE set equal to 100 in the base year and subsequent years' index values are calculated as the prior period's value plus the period change in the MFE score. This allows for tracking an individual MFE's probability over time without regard to how this MFE compares to other MFEs. For example, State 1 had no change in the tax increase probability between 2006 and 2007 but it increased by 1% point in 2008 relative to 2007, so the index value increased by 1 point.

Creating the MFE Index Value for a Grouping of Municipalities 1408

As shown in 1408 of FIG. 14, for each (j) MFE, an index is created by summing: the index value of each (i) entity times the revenue weight of each (i) entity.

As shown in the embodiment in FIG. 14, the solvency score for the group for 2006 is set as the base year (value=100) and subsequent years are calculated as the prior period's value plus the period change in the MFE score. For example, in FIG. 14, the MFE Index value Tax Increases for the State 1 & 2 grouping increased from 99.33 in 2007 to 99.67 in 2008 showing a worsening due to State 1 weakening and State 2 remaining the same as 2007.

MSX sub-indices can be calculated from scores associated with the probability of each individual material event. For example, the MSXTAX can be calculated as the average of each municipality's probability of a tax increase weighted by base year revenue. The MSXBLUE can be the average of a subset of the best (e.g., 25) municipality MSX scores, weighted by base year revenue, etc.

Once a solvency score is calculated for each municipality, the scores can be compiled into aggregate scores, e.g. the MSX150, (with 150 entities), or the MSXTAX, etc. by setting 2006 as the base year (value=100) and subsequent years are calculated as the prior period's index value plus the period change in the solvency score. The MSX for the State 1 and State 2 grouping is 100 in 2006, 100.443 in 2007 and 99.813 in 2008. In this illustrative example in FIG. 14, the overall solvency position of the group worsened in 2007 by 0.443% and then got better in 2008 by 0.63%.

The MSX index is an index that tracks financial solvency and is designed to reflect changes in a municipality's solvency position. When a municipality encounters financial challenges it will employ tactics that are reflective of financial difficulty, which are measured as MFEs. The index tracks the municipalities' financial solvency positions over time. Increases (decreases) in the index reflect more (less) financial difficulty. A one point increase (decrease) in the index is roughly equivalent to a one point increase (decrease) in the probability of one or more MFEs in the subsequent year.

In accordance with one or more embodiments, the models to predict MFEs form the basis for the creation of the MSX indices. Numerous indices can be created based off of a MSX database (e.g., MSX database 104) and the library of predictive models for the MFEs (e.g., predictive models 108). In accordance with one or more embodiments the indices include the “MSX150” which compiles an index value for tracking the financial strength of the largest states, counties and cities in the United States. Sub-indices of the MSX150 can include indices that track municipalities grouped by, but not limited to, the following attributes: most solvent, least solvent, most vulnerable to cash flow problems, most vulnerable to tax increases, most vulnerable to service cuts, most vulnerable to pensions, regional groups (e.g., north, east, etc.). In accordance with one or more embodiments, index values for all indices and sub-indices are set to equal 100 on Jun. 20, 2006.

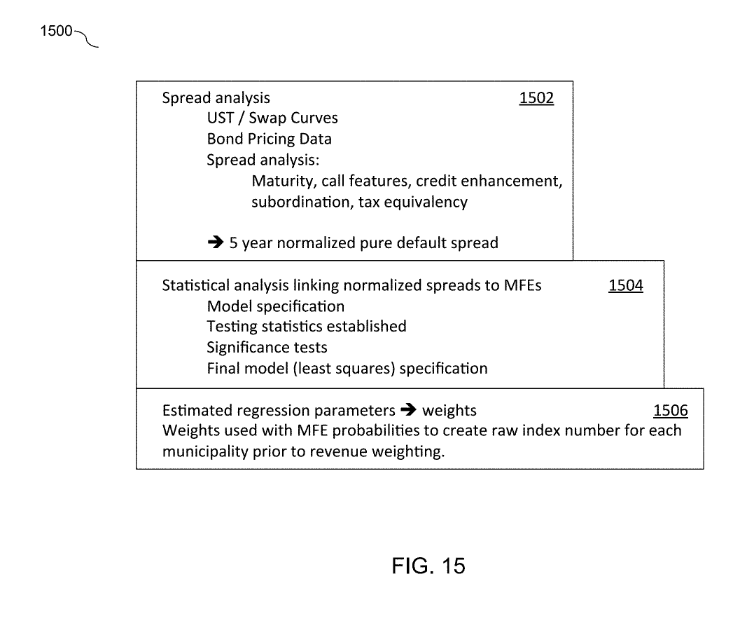

Turning now to FIG. 15, a process 1500 for performing bond market overlay, such as bond market overlay 1008, is generally shown in accordance with one or more embodiments. As shown in FIG. 15, performing bond market overlay includes spread analysis 1502, statistical analysis linking normalized spreads to MFEs 1504, and estimating regression parameters 1506.

In accordance with one or more embodiments, the updates are not limited to quarterly updates as all or a subset of the updates can occur on any periodic basis such as, but not limited to hourly, daily, weekly, monthly, etc. In addition, all or a subset of the updates can occur based on an external event (e.g., stock market level, interest range change, etc.).

Any number of sub-indices for either an individual MFE or for the solvency score (MSX) can be created from the 150 initial MSX entities captured in the MSX database. As the MSX database expands to cover a larger universe of municipal entities the number of potential indices will grow exponentially as increasing groupings can be formed from the new entrants combined with existing entities.

In accordance with one or more embodiments, the choice of the base year is arbitrary and a custom index can be created and calibrated with any given base year.

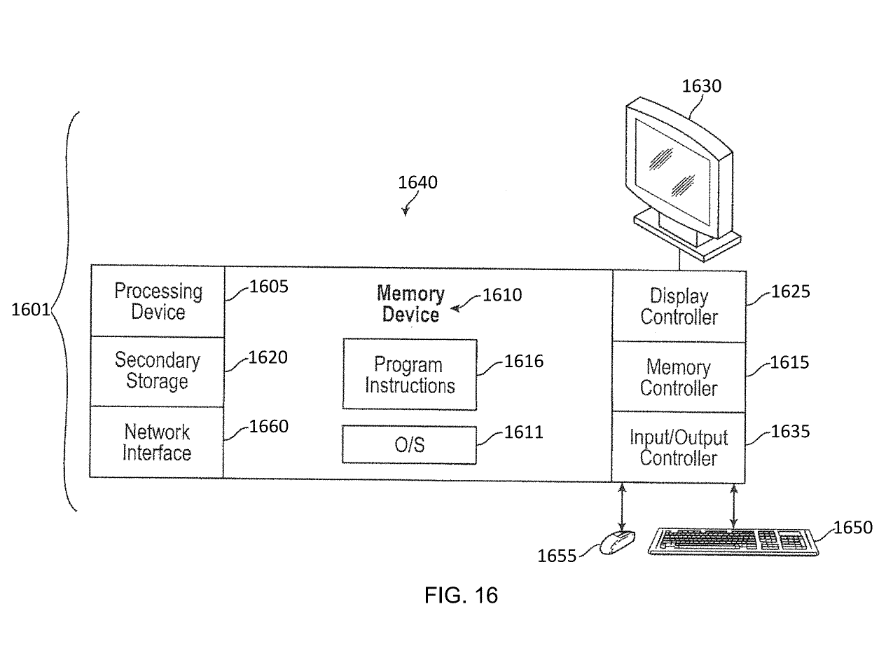

Turning now to FIG. 16, a system 1600 is depicted upon which one or more embodiments of a process for creating MSX indices can be implemented. In one or more exemplary embodiments, in terms of hardware architecture, as shown in FIG. 16, the computer 1601 includes a processing device 1605 and a memory device 1610 coupled to a memory controller 1615 and an input/output controller 1635. The input/output controller 1635 can be, for example, but not limited to, one or more buses or other wired or wireless connections, as is known in the art. The input/output controller 1635 may have additional elements, which are omitted for simplicity, such as controllers, buffers (caches), drivers, repeaters, and receivers, to enable communications. Further, the computer 1601 may include address, control, and/or data connections to enable appropriate communications among the aforementioned components.

In one or more exemplary embodiments, a keyboard 1650 and mouse 1655 or similar devices can be coupled to the input/output controller 1635. Alternatively, input may be received via a touch-sensitive or motion sensitive interface (not depicted). The computer 1601 can further include a display controller 1625 coupled to a display 1630.

The processing device 1605 is a hardware device for executing software, particularly software stored in secondary storage 1620 or memory device 1610. The processing device 1605 can be any custom made or commercially available computer processor, a central processing unit (CPU), an auxiliary processor among several processors associated with the computer 1601, a semiconductor-based microprocessor (in the form of a microchip or chip set), a macro-processor, or generally any device for executing instructions.

The memory device 1610 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), flash memory, programmable read only memory (PROM), tape, compact disc read only memory (CD-ROM), flash drive, disk, hard disk drive, diskette, cartridge, cassette or the like, etc.). Moreover, the memory device 1610 may incorporate electronic, magnetic, optical, and/or other types of storage media. Accordingly, the memory device 1610 is an example of a tangible computer readable storage medium 1640 upon which instructions executable by the processing device 1605 may be embodied as a computer program product. The memory device 1610 can have a distributed architecture, where various components are situated remote from one another, but can be accessed by the processing device 1605.

The instructions in memory device 1610 may include one or more separate programs, each of which comprises an ordered listing of executable instructions for implementing logical functions. In the example of FIG. 16, the instructions in the memory device 1610 include a suitable operating system (OS) 1611 and program instructions 1616. The operating system 1611 essentially controls the execution of other computer programs and provides scheduling, input-output control, file and data management, memory management, and communication control and related services. When the computer 1601 is in operation, the processing device 1605 is configured to execute instructions stored within the memory device 1610, to communicate data to and from the memory device 1610, and to generally control operations of the computer 1601 pursuant to the instructions. Examples of program instructions 1616 can include instructions to implement the processing described herein in reference to FIGS. 1-15.

The computer 1601 of FIG. 16 also includes a network interface 1660 that can establish communication channels with one or more other computer systems via one or more network links. The network interface 1660 can support wired and/or wireless communication protocols known in the art. For example, when embodied in a user system, the network interface 1660 can establish communication channels with an application server.

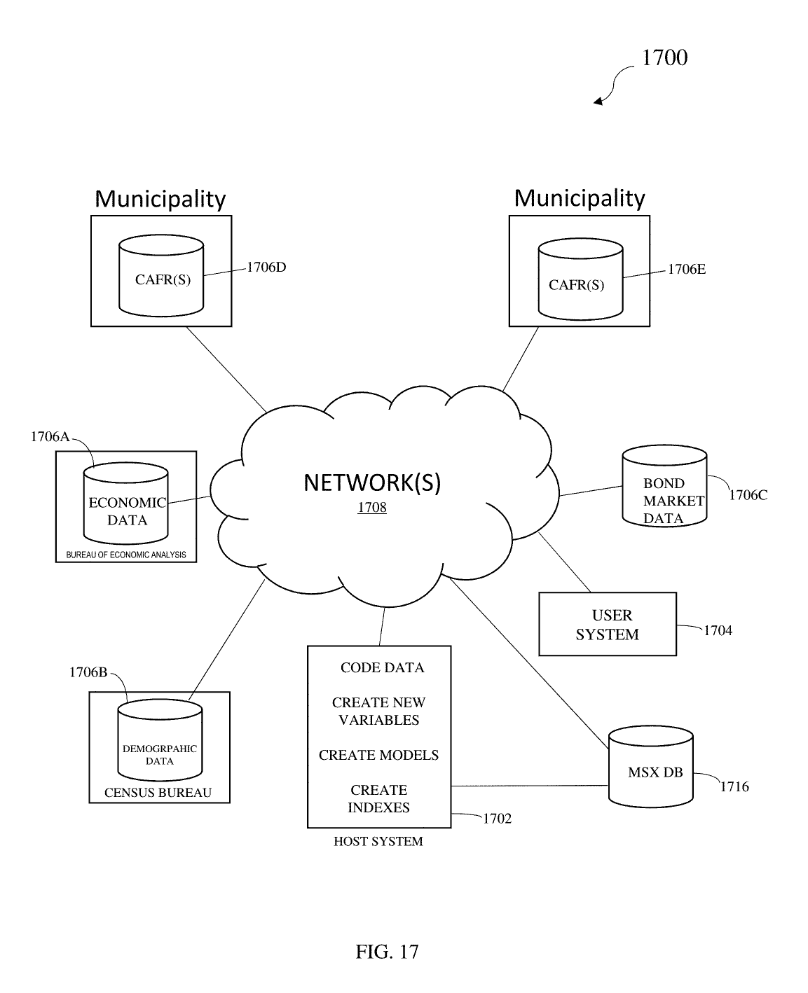

Turning now to FIG. 17, a system 1700 upon which the creating of an MSX database and MSX index(es) may be implemented is generally shown in accordance with one or more embodiments of the present invention. The system 1700 includes a host system computer 1702, a user system 1704, and data provider sources 1706A-1706E, each of which is communicatively coupled to one or more networks 1708. The host system computer 1702 may be implemented as a high-speed computer processing device for handling the volume of activities associated with creating the MSX database and index(es) as well as the users of MSX index(es). In an embodiment, the host system computer 1702 is operated by a service provider enterprise.

The user system 1704 may be operated by an end user of the MSX index(es) described herein. The user system 1704 may also be operated by a user who facilitates the creation of the MSX database and index(es). The user system 1704 may be implemented as a general-purpose computer (e.g., desktop or laptop). Alternatively, the user system 1704 may be implemented as a mobile device, such as a smart phone, tablet, or personal digital assistant. While only one user system 1704 is shown in FIG. 17 for ease of illustration, it will be understood that any number of user systems may be employed in order to realize the advantages of the exemplary embodiments

Data provider sources 1706 each store data used to create the MSX database and index(es). As shown in FIG. 17, data provider sources can include economic data 1706A (e.g., from the Bureau of Economic Analysis), demographic data 1706B (e.g., from the Census Bureau), bond market data 1706C, CAFRs 1706D (from a municipality), and CAFRs 1706E (from a different municipality. While only two municipalities are shown in FIG. 17 for ease of illustration, it will be understood that CAFRs from any of the municipalities tracked in the MSX database 1716 are available. While only economic data 1706A, demographic data 1706B, and bond market data 1706C are shown in FIG. 17 for ease of illustration, it will be understood that any of the sources of data described herein are available. In accordance with an embodiment, data from the data provider sources 1706 are accessed/downloaded and coded using user system 1704.

The host system computer 1702, as a service provider to the users of user system 1704, implements an application to facilitate the creating of the MSX database 1716 and MSX index(es). As shown in FIG. 17, the application executing on the host computer system 1702 includes logic to facilitate coding data from the various data provider sources 1706, create new variables, create model(s), and create index(es).

The system 1700 of FIG. 17 also includes the MSX database 1716 located for example, on a storage device that is communicatively coupled to the host system computer 1702. The storage device where the MSX database 1716 is located may be implemented using a variety of devices for storing electronic information. It is understood that the storage device may be implemented using memory contained in the host system computer 1702 or it may be a separate physical device. The storage device may be logically addressable as a consolidated data source across a distributed environment that includes the networks 1708. Information stored in the storage device may be retrieved and manipulated via the host system computer 1702 and authorized users, such as the user system 1704.

In an embodiment, the host system computer 1702 operates as a database server and coordinates access to application data including the MSX database 1716 stored on storage device 1716.

The networks 1708 may be any type of known networks including, but not limited to, a wide area network (WAN), a local area network (LAN), a global network (e.g. Internet), and an intranet. The networks 1708 may be implemented using wireless networking technologies or any kind of physical network implementation known in the art. User system 1704 and data provider sources 1706 may be coupled to the host system computer 1702 through multiple networks (e.g., Internet, intranet, and private network) so that not all systems are coupled to the host system computer 1702 through the same networks.

In accordance with one or more embodiments of the invention, the data system 1700 shown in FIG. 17 performs the data capture, data manipulation, data storage, data usage to construct predictive models and indices, and ultimate predictions of MFE and indices using a distributed technology such as blockchain. For example, source data can be retrieved from data provider sources 1700 and stored on a blockchain (node) such as the storage device containing the MSX database 1716 or the MSX database 1716 or another node location (not shown) via network 1708. The data can then be coded (e.g., manually by a user at user system 1704) and then re-stored on the blockchain. The coded data can be retrieved from the blockchain, manipulated, and combined within the blockchain to produce output to different nodes on the blockchain.

Each time a subscriber wants the data, they can access a permissioned node on the blockchain (e.g., via user system 1704). Different versions or portions of the data created by embodiments described herein can be distributed to different audiences via the blockchain. In one example, a home builder may want to know which cities have the best cash flow. One or more embodiments described herein can provide a subscription that allows the home builder to access data that indicates cash flow by municipality. Another customer may be a school bus company that wants to know which towns in the Midwest are most likely to cut spending on education. A subscription can be provided to the school bus company that allows access to data that indicates education spending per person under 18 by municipality. Another customer may be interested in a solvency score on all 50 states and have a subscription that provides access to these scores. In this manner, customers can purchase subscriptions for the particular data that they are interested in.

The data in the MSX database 1716, which includes data for municipalities (e.g., 250) times the number of variables (e.g., 200) times the number of years (e.g., 10) can be combined in a huge number of ways. The blockchain allows subscribers to get customized access (to create their own “carts”). Each individual user can access the municipalities that they want in their bucket (“cart”) and can have the blockchain run the algorithm that combines the individual municipalities into a customized overall index or sub-index. In addition, the use of blockchain provides full auditability of the data which is important for data integrity.

Technical effects and benefits include the ability to create new variables for generating the index(es) based on contents of the data sources. Data from one data source can be enhanced by combining it with data from another data source. The enhanced data can be stored in the MSX database. For example, historical data that tracks a pattern of expenditures of a municipality over time can be combined to predict future tax increases, which can be stored in the MSX database. Another example is that tax revenue data from a CAFR produced by a town can be combined with demographic data produced, for example, by a government agency to generate a variable that indicates a tax per capita that includes all of the people in the town or just those within a particular age range.

Technical effects and benefits also include the ability to collect data from a variety of sources, codify the data, and generate new variables based at least in part on the codified data. As described herein, the data in CAFRs is generally not uniform. CAFRs in different municipalities often use different terminology and they classify entries such as expenditures and income differently.

Technical effects and benefits also include the use of rules based machine learning to generate the index(es) based on the variables in the MSX database. The model can be built based on correlations and other dependencies found in historical data in order to predict a chance of a material financial event based on the current variables (also referred to herein as data). The rules based machine learning makes use of algorithmic mining of the data to combine variables, such as personal income (one variable) per municipal employee (a second variable) and derivatives of variables, such as the change in personal income per municipal employee over the past year. Combining variables and creating new variables are used to produce structural models which identify precisely which combination of variables and their derivatives are the best predictors of material financial events. As the MSX database is updated and grows with source data, the new variables created within the MSX database also grow and the rules-based machine driven algorithms are re-run to update the statistical specifications of the structural model.

Taking the source data and uniquely codifying it at its most disaggregate level is novel. Combining the disaggregate data into meaningful units that can be compared across municipalities, on an apples-to-apples basis is also novel. Creating new variables through combinations across variables, including data from disparate sources (Bureau of Economic Analysis, Census Bureau, etc.) and creating derivatives of these variables is also novel. The ability to link off-balance sheet and other financial data associated with another legal entity to a particular municipality is also novel. The resulting MSX database which produces new statistics for each municipality based on source data from a variety of sources, combined with other variables to create new variables including their derivatives is also novel. Having algorithmic processes to absorb updated source data and otherwise new data into to the MSX database which automatically re-estimates parameters of structural statistical models is also novel. Using the outputted parameters to update the predictive models for MFEs is also novel. Using the predicted values to update the individual indexes is novel. Running rules-based algorithms to combine the individual indices into a composite value, where the weights used to create the combination are also periodically and automatically statistically re-estimated with the machine based algorithms based on the updated data from the MSX database is novel. Other than the coding, the updates are done automatically with a computer.

Also, as described above, the data can be stored on a blockchain and can be accessible via permissions to end users. Subscribers to the MSX database can access certain data of interest, such as education spending per municipality for cities and town, or the probability of a tax increase for the largest 250 municipalities, or source data for a given list of municipalities. Blockchain distribution allows bespoke blockchains, permissioned to many different end users (subscribers) of the data. Blockchain technology also allows for storage of the data at all points of its lifecycle—source data, the codified data from CAFRs, the new variables created in the MSX database, any particular fields of the MSX database, the probability of a certain MFE.

Set forth below are some embodiments of methods for creating a municipal solvency index.

### Embodiment 1

A non-limiting example method includes creating a municipal solvency (MSX) database, the creating includes collecting and coding data from public sources about a plurality of municipalities. Predictive models are generated based on contents of the MSX database, the predictive models describing drivers of municipal solvency and predictors of material financial events (MFEs) for each of the municipalities. Probabilities of one or more MFEs are predicted for each of the municipalities, the estimating based on the predictive models. Indices that reflect solvency and a probability of an MFE for at least one of the municipalities are created. The indices are output.

### Embodiment 2

The method of Embodiment 1, wherein the data available from public sources include one or more of comprehensive annual financial report (CAFR) data, demographic data, economic data, and bond market data.

### Embodiment 3

The method of any of Embodiments 1-2, wherein standard reporting classifications and standard legal entities are defined across a plurality of municipalities in the MSX database, thereby allowing CAFRs of different formats and contents to be compared.

### Embodiment 4

The method of any of Embodiments 1-3, wherein the MFEs include one or more of a tax increase, an expenditure cut, a service deterioration, a cash flow shortfall, and a pension shortfall.

### Embodiment 5

The method of any of Embodiments 1-4, wherein the MSX database is updated on a periodic basis, and the generating, estimating and creating are performed in response to the MSX database being updated.

### Embodiment 6

The method of any of Embodiments 1-5, wherein each index corresponds to a single municipality.

### Embodiment 7

The method of any of Embodiments 1-6, wherein each index corresponds to a plurality of municipalities.

### Embodiment 8

The method of any of Embodiments 1-7, wherein the MSX database includes data for each municipality that spans a plurality of years.

### Embodiment 9

The method of any of Embodiments 1-8, further including further comprising determining financial events to be included as MFEs.

### Embodiment 10

The method of any of Embodiments 1-9, wherein the determining is based on an analysis of the data in the MSX database.

### Embodiment 11

A system that includes a memory having computer readable instructions; and one or more processors for executing the computer readable instructions, the computer readable instructions controlling the one or more processors to perform any of Embodiments 1-10.

### Embodiment 12

A computer program including a computer storage medium having program instructions embodied therewith, the program instructions executable by a processor to cause the process to implement any of Embodiments 1-10.

It will be appreciated that aspects of the present invention may be embodied as a system, method, or computer program product and may take the form of a hardware embodiment, a software embodiment (including firmware, resident software, micro-code, etc.), or a combination thereof. Furthermore, aspects of the present invention may take the form of a computer program product embodied in one or more computer readable medium(s) having computer readable program code embodied thereon.

One or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In one aspect, the computer readable storage medium may be a tangible medium containing or storing a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

The computer readable medium may contain program code embodied thereon, which may be transmitted using any appropriate medium, including but not limited to wireless, wireline, optical fiber cable, RF, etc., or any suitable combination of the foregoing. In addition, computer program code for carrying out operations for implementing aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

It will be appreciated that aspects of the present invention are described herein with reference to flowchart illustrations and/or block diagrams of methods, apparatus (systems) and computer program products according to embodiments of the invention. It will be understood that each block or step of the flowchart illustrations and/or block diagrams, and combinations of blocks or steps in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed general purpose computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

What is claimed is:

1. A computer implemented method comprising:
creating a municipal solvency (MSX) database, the creating comprising collecting and coding data from public sources about a plurality of municipalities;
generating predictive models based on contents of the MSX database, the predictive models describing drivers of municipal solvency and predictors of material financial events (MFEs) for each of the municipalities;
estimating probabilities of one or more MFEs for each of the municipalities, the estimating based on the predictive models;
creating indices that reflect solvency and a probability of an MFE for at least one of the municipalities; and
outputting the indices.

2. The method of claim 1, wherein the data available from public sources include one or more of comprehensive annual financial report (CAFR) data, demographic data, economic data, and bond market data.

3. The method of claim 1, wherein standard reporting classifications and standard legal entities are defined across a plurality of municipalities in the MSX database, thereby allowing CAFRs of different formats and contents to be compared.

4. The method of claim 1, wherein the MFEs include one or more of a tax increase, an expenditure cut, a service deterioration, a cash flow shortfall, and a pension shortfall.

5. The method of claim 1, wherein the MSX database is updated on a periodic basis, and the generating, estimating and creating are performed in response to the MSX database being updated.

6. The method of claim 1, wherein each index corresponds to a single municipality.

7. The method of claim 1, wherein each index corresponds to a plurality of municipalities.

8. The method of claim 1, wherein the MSX database includes data for each municipality that spans a plurality of years.

9. The method of claim 1, further comprising determining financial events to be included as MFEs.

10. The method of claim 9, wherein the determining is based on an analysis of the data in the MSX database.

11. A system comprising:
a memory having computer readable instructions; and
one or more a processors for executing the computer readable instructions, the computer readable instructions including:
creating a municipal solvency (MSX) database, the creating comprising collecting and coding data from public sources about a plurality of municipalities;
generating predictive models based on contents of the MSX database, the predictive models describing drivers of municipal solvency and predictors of material financial events (MFEs) for each of the municipalities;
estimating probabilities of one or more MFEs for each of the municipalities, the estimating based on the predictive models;
creating indices that reflect solvency and a probability of an MFE for at least one of the municipalities; and
outputting the indices.
creating a municipal solvency (MSX) database, the creating comprising collecting and coding data from public sources about a plurality of municipalities;
generating predictive models based on contents of the MSX database, the predictive models describing drivers of municipal solvency and predictors of material financial events (MFEs) for each of the municipalities;
estimating probabilities of one or more MFEs for each of the municipalities, the estimating based on the predictive models;
creating indices that reflect solvency and a probability of an MFE for at least one of the municipalities; and
outputting the indices.

12. The system of claim 11, wherein the data available from public sources include one or more of comprehensive annual financial report (CAFR) data, demographic data, economic data, and bond market data.

13. The system of claim 11, wherein standard reporting classifications and standard legal entities are defined across a plurality of municipalities in the MSX database, thereby allowing CAFRs of different formats and contents to be compared.

14. The system of claim 11, wherein the MFEs include one or more of a tax increase, an expenditure cut, a service deterioration, a cash flow shortfall, and a pension shortfall.

15. The system of claim 11, wherein the MSX database is updated on a periodic basis, and the generating, estimating and creating are performed in response to the MSX database being updated.

16. The system of claim 11, wherein the MSX database includes data for each municipality that spans a plurality of years.

17. The system of claim 11, wherein the determining is based on an analysis of the data in the MSX database.

18. A computer program product comprising a computer readable storage medium having program instructions embodied therewith, the program instructions executable by a processor to cause the processor to perform:
creating a municipal solvency (MSX) database, the creating comprising collecting and coding data from public sources about a plurality of municipalities;
generating predictive models based on contents of the MSX database, the predictive models describing drivers of municipal solvency and predictors of material financial events (MFEs) for each of the municipalities;
estimating probabilities of one or more MFEs for each of the municipalities, the estimating based on the predictive models;
creating indices that reflect solvency and a probability of an MFE for at least one of the municipalities; and
outputting the indices.

19. The computer program product of claim 18, wherein standard reporting classifications and standard legal entities are defined across a plurality of municipalities in the MSX database, thereby allowing CAFRs of different formats and contents to be compared.

20. The computer program product of claim 18, wherein the determining is based on an analysis of the data in the MSX database.
